(19) United States
(12) Patent Application Publication
(10) Pub. No.: US 2026/0018820 A1
(43) Pub. Date: Jan. 15, 2026

(54) ELECTRICAL CONNECTOR, CONDUCTIVE TERMINAL AND FORMING METHOD THEREOF

(71) Applicant: LOTES CO., LTD, Keelung (TW)

(72) Inventors: Lin Han, Guangzhou (CN); Chih Kun Chen, Keelung (TW)

(21) Appl. No.: 19/027,067

(22) Filed: Jan. 17, 2025

(30) Foreign Application Priority Data
Jul. 10, 2024 (CN) 202410922179.X

(51) Int. Cl. H01R 13/24; H01R 13/6586; H01R 43/16

(52) U.S. Cl. CPC H01R 13/2407; H01R 13/6586; H01R 43/16

(57) ABSTRACT

An electrical connector, a conductive terminal and a forming method of a conductive portion of the conductive terminal. The conductive portion of the conductive terminal includes two elastic arms elastically abutting against a metal pad of a circuit board. Each elastic arm includes a first arm portion and a second arm portion separated along an up-down direction. A contact portion is formed at a tail end of the second arm portion, which does not form an open stub. Each contact portion has a tearing surface, such that a distance between the two contact portions of the two elastic arms is minimized. The two contact portions of the two elastic arms are provided to be staggered along the front-rear direction, and the two tearing surfaces of the two elastic arms are staggered along a front-rear direction, thus preventing the two elastic arms from scratching and colliding with each other.

### CROSS-REFERENCE TO RELATED PATENT APPLICATION

This non-provisional application claims priority to and the benefit of, pursuant to 35 U.S.C. § 119(a), patent application Serial No. CN202410922179.X, filed in China on Jul. 10, 2024. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector and a conductive terminal thereof, and particularly to a conductive terminal elastically abutting against a circuit board, an electrical connector and a forming method of the conductive terminal.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Modern data centers process massive amounts of data at all times. To meet the ever-growing demands, the electrical connectors used in a data center or similar environments are required to achieve a transmission rate of 224 Gb/s. Referring to Chinese Patent No. CN107093811B, traditionally, such electrical connector is commonly electrically connected to a circuit board using the press-fit technology. That is, the surface of the circuit board has conductive through holes, and the conductive terminals of the electrical connector have press-fit portions that are radially compressible and deformable. The press-fit portions are inserted into the conductive through holes with smaller dimensions and are in contact with the conductive layers on the side surfaces of the through holes, thereby forming the electrical connections. However, only a portion of each press-fit portion is in contact with the through hole. For example, in CN107093811B, only the opening portion of each press-fit portion is in contact with the conductive layers on the side surfaces of the through hole, while the tip below the opening portion is not in contact with the through hole. The tip is used to guide the entire press-fit portion into the through hole, and its dimension is smaller than the diameter of the through hole, such that it is not in contact with the through hole. Accordingly, the tip does not constitute part of the signal transmission path, thereby forming an open stub. When transmitting signals at the rate of 224 Gb/s, the open stub may easily induce resonance, causing electromagnetic interference and damaging the signal integrity.

Therefore, a heretofore unaddressed need to design a new electrical connector exists in the art to address the aforementioned deficiencies and inadequacies.

### SUMMARY

In view of the background technology, the present invention is directed to an electrical connector, a conductive terminal and a forming method of a conductive portion of the conductive terminal, in which the conductive portion of the conductive terminal includes two elastic arms, and each elastic arm includes a first arm portion and a second arm portion separated along an up-down direction. A contact portion is located at a tail end of the second arm portion, and the contact portion does not form an open stub when it elastically contacts with the metal pad of a circuit board, thus preventing from generating the high frequency resonance and corresponding electromagnetic interferences. The closest surfaces of the two contact portions are tearing surfaces, and the two tearing surfaces are also the closest surfaces of the two elastic arms. The two tearing surfaces allows the distance between the two contact portions in the left-right direction to be minimized, and on the premise of not reducing the original width of the contact portion, the dimension of the metal pad of the circuit board simultaneously in contact with the two contact portions in the left-right direction may be correspondingly reduced, thus preventing the metal pad from having an excessively low impedance, which helps the entire electrical connecting system to facilitate better characteristic impedance matching. In addition, the two second arm portions extend to be close toward each other in the front-rear direction, which may allow the contact portions located at the tail ends of the second arm portions to be close to each other in the front-rear direction, thus reducing the dimension of the metal pad in the front-rear direction correspondingly. The two contact portions of the two elastic arms are provided to be staggered in the front-rear direction, and the two tearing surfaces are provided to be separated along the front-rear direction. The two tearing surfaces, after elastically abutting against the metal pad, move away from each other along the respective extending directions of the two second arm portions, thus preventing the two tearing surfaces closest to each other on the two elastic arms from scratching and colliding with each other in the elastic compression process of the elastic arms, thereby preventing the two contact portions from failing to align to and abut against the same metal pad due to colliding with each other.

To achieve the foregoing objective, the present invention adopts the following technical solutions:

A conductive terminal includes: a base, extending along an up-down direction; and a conductive portion, connected to the base and configured to elastically abut against a circuit board. The conductive portion comprises two elastic arms, each of the elastic arms comprises a first arm portion and a second arm portion separated along the up-down direction, a bending portion connecting the first arm portion and the second arm portion, and a contact portion located at a tail end of the second arm portion, the two first arm portions of the two elastic arms extend to be away from each other in a front-rear direction, the two second arm portions of the two elastic arms extend to be close to each other in the front-rear direction, the contact portion of each of the two elastic arms has a tearing surface facing toward the second arm portion of the other of the two elastic arms, a distance between the two tearing surfaces of the two elastic arms in a left-right direction is a shortest distance between the two elastic arms in the left-right direction, the two contact portions of the two elastic arms are provided to be staggered along the front-rear direction, and the two tearing surfaces are provided to be separated along the front-rear direction.

In certain embodiments, the first arm portion is directly connected to the base, one of the two tearing surfaces of the two elastic arms passes beyond a front side of the base, and the other of the two tearing surfaces passes beyond a rear side of the base.

In certain embodiments, lengths, corresponding widths and shapes of the two elastic arms are substantially identical.

In certain embodiments, each of the elastic arms further has a blanking surface located between the contact portion and the base at a side adjacent to the other of the elastic arms, and the tearing surface of each of the two elastic arms and the blanking surface of the other of the elastic arms are opposite to each other in the left-right direction.

In certain embodiments, the contact portion of each of the two elastic arms extends toward the second arm portion of the other of the two elastic arms in the left-right direction, and a sum of widths of the two contact portions of the two elastic arms in the left-right direction is less than a distance between two edges of the two second arm portions of the two elastic arms away from each other.

In certain embodiments, the two tearing surfaces of the two elastic arms and a central axial line of the base extending along the up-down direction are located on a same vertical plane.

In certain embodiments, a same side of the two contact portions of the two elastic arms along the up-down direction form two contact surfaces to collectively abut against a same metal pad of the circuit board.

In certain embodiments, a width of the contact portion in the left-right direction is less than a width of the second arm portion, a mating portion extends from a side of the base away from the conductive portion along the up-down direction, and a width of the mating portion is greater than a sum of the widths of the two contact portions of the two clastic arms.

In certain embodiments, a portion of each of the first arm portions of the elastic arms substantially extends horizontally along the front-rear direction.

An electrical connector includes: an insulating body; and a plurality of transmission modules fixed in the insulating body. Each of the transmission modules comprises a shielding sleeve, an insulating block surrounded by the shielding sleeve and a differential terminal group fixed to the insulating block, the differential terminal group comprises two conductive terminals, each of the two conductive terminals comprises a base extending along an up-down direction, a mating portion connected to one side of the base and a conductive portion connected to the other side of the base, and the conductive portion is configured to be electrically connected to a circuit board. The conductive portion comprises two elastic arms, each of the elastic arms comprises a first arm portion and a second arm portion separated along the up-down direction, a bending portion connecting the first arm portion and the second arm portion, and a contact portion located at a tail end of the second arm portion, the two first arm portions of the two elastic arms extend to be away from each other in a front-rear direction, the two second arm portions of the two elastic arms extend to be close to each other in the front-rear direction, the contact portion of each of the two elastic arms has a tearing surface facing toward the second arm portion of the other of the two elastic arms in a left-right direction, each of the elastic arms further has a blanking surface located between the contact portion and the base at a side adjacent to the other of the elastic arms, a distance between the two tearing surfaces of the two elastic arms in the left-right direction is a shortest distance between the two blanking surfaces of the two elastic arms in the left-right direction, the two contact portions of the two elastic arms are provided to be staggered along the front-rear direction, and the two tearing surfaces are provided to be separated along the front-rear direction.

In certain embodiments, the two conductive portions of the same differential terminal group are side-by-side along the left-right direction and are symmetrical by 180° rotating around a central point of an interval therebetween.

In certain embodiments, the two conductive portions of the same differential terminal group are side-by-side along the left-right direction and are mirror symmetrical relative to a central line of an interval therebetween.

In certain embodiments, in a same one of the conductive terminals, one of the two tearing surfaces of the two elastic arms passes beyond a front side of the base, and the other of the two tearing surfaces passes beyond a rear side of the base.

In certain embodiments, in a same one of the conductive terminals, the tearing surface of each of the two elastic arms and the blanking surface of the other of the elastic arms are opposite to each other in the left-right direction.

In certain embodiments, a farthest distance between each of the two bending portions and the base of a same one of the conductive terminals in the front-rear direction is substantially equal.

In certain embodiments, in a same one of the conductive terminals, the contact portion of each of the two elastic arms extends toward the second arm portion of the other of the two elastic arms in the left-right direction, and a sum of widths of the two contact portions of the two elastic arms in the left-right direction is less than a distance between two edges of the two second arm portions of the two elastic arms away from each other.

In certain embodiments, a width of the contact portion in the left-right direction is less than a width of the second arm portion, and a width of the mating portion is greater than a sum of the widths of the two contact portions of the two elastic arms.

In certain embodiments, in a same one of the conductive terminals, the two contact portions of the two elastic arms collectively abut against a same metal pad of the circuit board.

In certain embodiments, in a same one of the conductive terminals, two projections of the two elastic arms along the up-down direction are symmetrical by 180° rotating.

A forming method of a conductive portion of a conductive terminal includes: providing a metal substrate and forming a base and a ring portion of the conductive terminal on the metal substrate by punching and blanking technology, wherein the ring portion is connected to the base and has a through hole at a center thereof, and a tail end of the ring portion has a pre-breaking slot connected to the through hole; breaking the tail end of the ring portion by punching and tearing technology, and breaking the ring portion along the pre-breaking slot to form two extending portions splitting in a front-rear direction, wherein a tail end of each of the extending portions has a tearing surface formed by breaking with the pre-breaking slot; and bending the two extending portions respectively by a bending jig to form two elastic arms, wherein each of the elastic arms has a first arm portion connected to the base, a bending portion connected to the first arm portion, a second arm portion connected to the bending portion and a contact portion located at a tail end of the second arm portion, the two first arm portions of the two elastic arms extend from the base to be away from each other in a front-rear direction, the two second arm portions of the two elastic arms extend from the two bending portions of the two elastic arms to be close to each other in the front-rear direction, and the two tearing surfaces of the two elastic arms are respectively located at a side of the two contact portions of the two elastic arms adjacent to each other, the two contact portions of the two elastic arms are provided to be staggered along the front-rear direction, and the two tearing surfaces are provided to be separated along the front-rear direction.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is an exploded schematic view of an electrical connector according to certain embodiments of the present invention.

FIG. 2 is a schematic view of a differential terminal group formed by conductive terminals according to a first embodiment of the present invention.

FIG. 3 is a top view of FIG. 2.

FIG. 4 is a schematic view of the differential terminal group elastically abutting against metal pads of a circuit board.

FIG. 5 is a left view of FIG. 2.

FIG. 6 is a schematic view of a forming process of a conductive portion of a conductive terminal according to certain embodiments of the present invention.

FIG. 7 is a schematic view of a differential terminal group formed by conductive terminals according to a second embodiment of the present invention.

FIG. 8 is a top view of FIG. 7.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

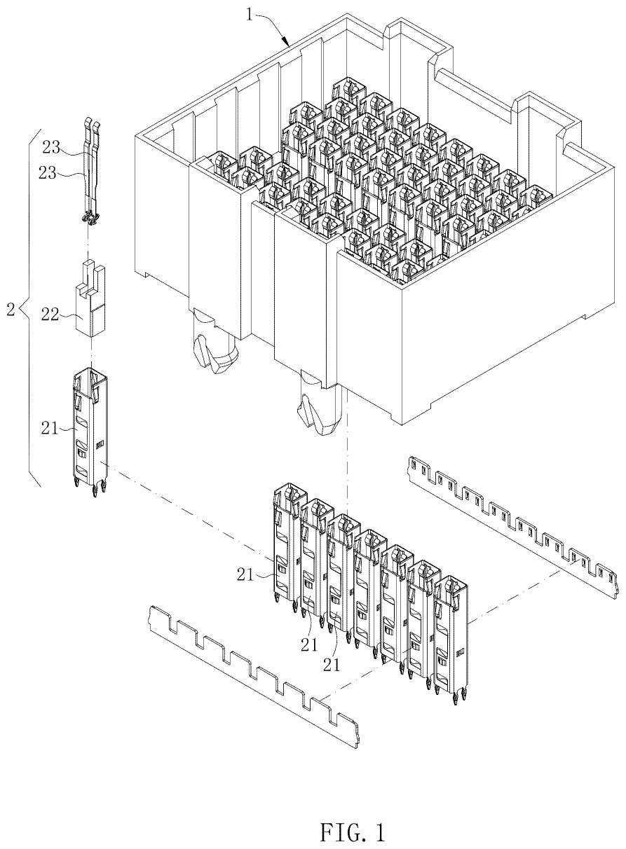

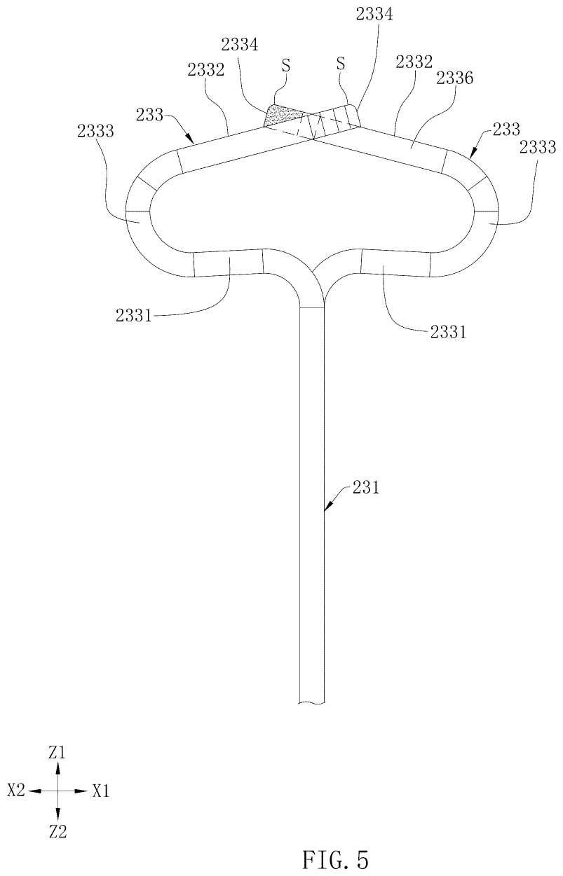

The description will be made as to the embodiments of the present invention in conjunction with the accompanying drawings in FIGS. 1-8. In accordance with the purposes of this invention, as embodied and broadly described herein, this invention, in one aspect, relates to an electrical connector assembly with an electrical connector, a conductive terminal and a forming method of the conductive terminal.

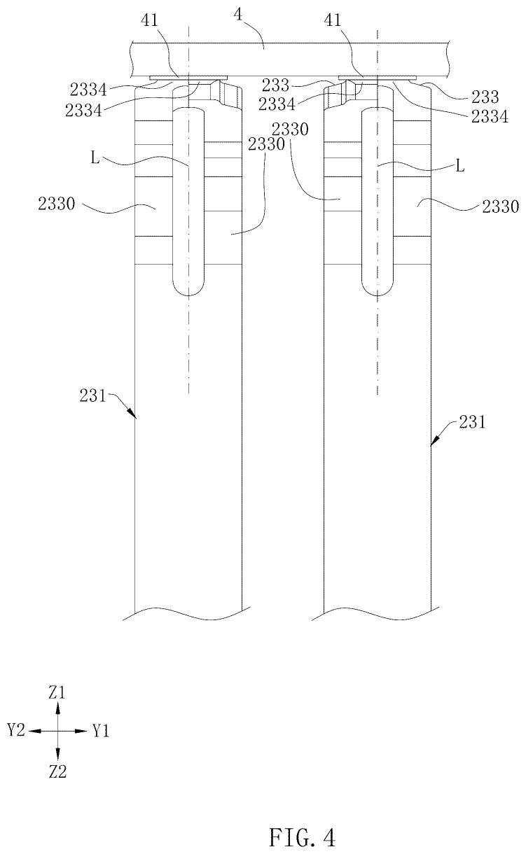

FIG. 1 is a schematic view of an electrical connector according to certain embodiments of the present invention. The electrical connector includes an insulating body 1 and a plurality of transmission modules 2 fixed in the insulating body 1. Each transmission module 2 includes a shielding sleeve 21, an insulating block 22 surrounded by the shielding sleeve 21 and a differential terminal group fixed to the insulating block 22. The differential terminal group includes two conductive terminals 23 to transmit differential signals. Each conductive terminal 23 includes a base 231 extending along an up-down direction, a mating portion 232 connected to one side of the base 231 and a conductive portion 233 connected to the other side of the base 231. The mating portion 232 is used to be electrically connected to a mating terminal of a mating connector (not shown), and the conductive portion 233 is used to be elastically abut against a metal pad 41 of a circuit board 4 (also referring to FIG. 4).

For convenience of description in details with reference to the accompanying drawings, the X1X2 direction in the drawings is defined as a front-rear direction, the Y1Y2 direction in the drawings is defined as a left-right direction, and the Z1Z2 direction in the drawings is defined as the up-down direction, which are not intended to limit the usage directions of the present invention.

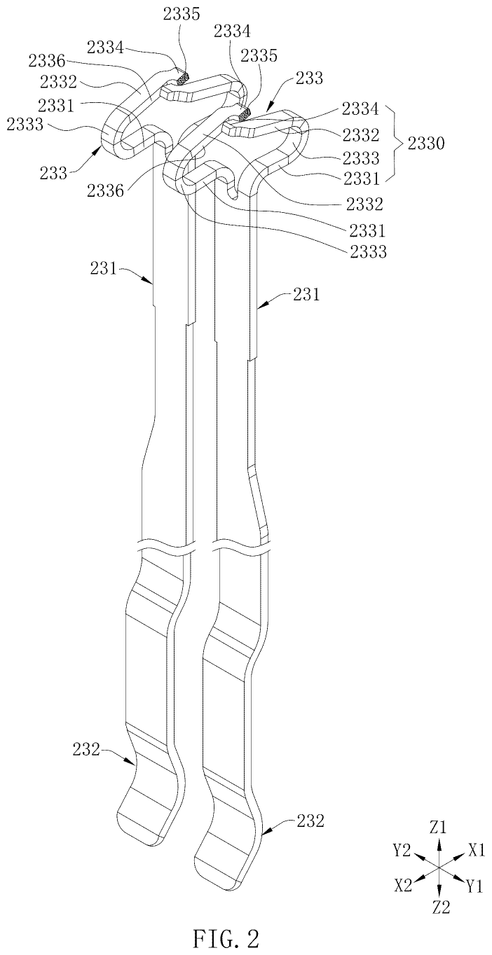

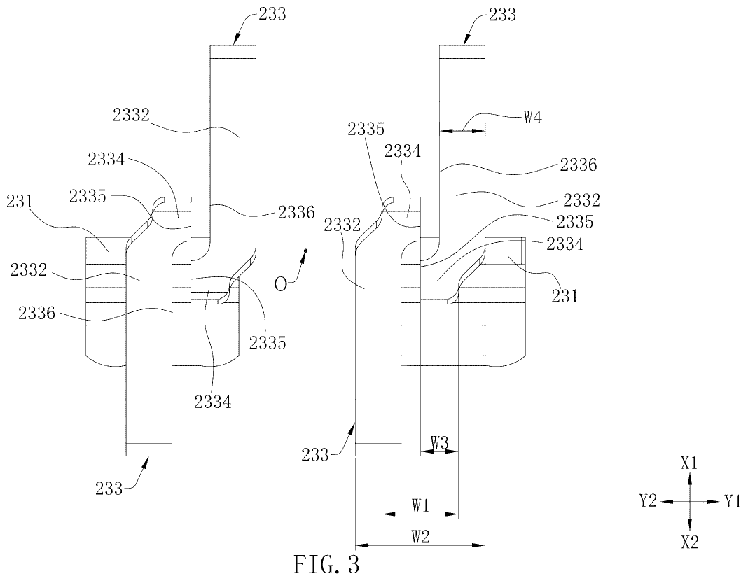

FIG. 2 to FIG. 5 are schematic views of the differential terminal group according to a first embodiment. Referring to FIG. 3, in the present embodiment, the two conductive portions 233 of the same differential terminal group are side-by-side along the left-right direction and are symmetrical by 180° rotating around a central point O of an interval therebetween. The conductive portion 233 includes two elastic arms 2330, and each elastic arm 2330 includes a first arm portion 2331 and a second arm portion 2332 separated along the up-down direction, a bending portion 2333 connecting the first arm portion 2331 and the second arm portion 2332, and a contact portion 2334 located at a tail end of the second arm portion 2332. In the present embodiment, the contact portion 2334 is located at a tail end of the second arm portion 2332 and extends toward the second arm portion 2332 of the other elastic arm 2330 in the left-right direction. In the same conductive terminal 23, the two first arm portions 2331 of the two elastic arms 2330 extend to be away from each other in the front-rear direction, and the two second arm portions 2332 of the two clastic arms 2330 extend to be close to each other in the front-rear direction. The same side of the two contact portions 2334 of the two elastic arms 2330 along the up-down direction form two contact surfaces S to collectively abut against a same metal pad 41 of the circuit board 4, such that the conductive terminal 23 is electrically connected to the circuit board 4, and forms two signal transmission paths with the circuit board 4 by the two elastic arms 2330.

The contact portion 2334 of each of the two elastic arms 2330 has a tearing surface 2335 facing toward the second arm portion 2332 of the other of the two elastic arms 2330, and the two tearing surfaces 2335 are formed by tearing from the two contact portions 2334 so that the two tearing surfaces 2335 are separated in the front-rear direction. As shown in FIG. 3 and FIG. 4, a distance between the two tearing surfaces 2335 of the two elastic arms 2330 in a left-right direction is a shortest distance between the two elastic arms 2330 in the left-right direction, and in an ideal condition, projections of the two tearing surfaces 2335 along the front-rear direction are aligned. That is, the two tearing surfaces 2335 and a central axial line L of the base 231 extending along the up-down direction are located on a same vertical plane, and a minimum value of the distance between the two tearing surfaces 2335 in the left-right direction may be 0. To prevent the contact portions 2334 of the two clastic arms 2330 from colliding with each other in the elastic compression process, the two contact portions 2334 of the two elastic arms 2330 are provided to be staggered along the front-rear direction, and the two tearing surfaces 2335 are provided to be separated along the front-rear direction. In the present embodiment, as shown in FIG. 3, one of the two tearing surfaces 2335 passes beyond a front side of the base 231, and the other tearing surface 2335 passes beyond a rear side of the base 231. Further, in the present embodiment, each elastic arm 2330 further has a blanking surface 2336 located between the contact portion 2334 and the base 231. As shown in FIG. 3 and FIG. 4, in the same conductive portion 233, a distance between the two blanking surfaces 2336 of the two elastic arms 2330 in the left-right direction is greater than the distance between the two tearing surfaces 2335 of the two elastic arms 2330 in the left-right direction. The tearing surface 2335 of each of the two elastic arms 2330 and the blanking surface 2336 of the other of the elastic arms 2330 are opposite to each other in the left-right direction, and each contact portion 2334 extends toward the second arm portion 2332 of the other elastic arm 2330 in the left-right direction. A sum W1 of widths of the two contact portions 2334 in the left-right direction is less than a distance W2 between two edges of the two second arm portions 2332 of the two elastic arms 2330 away from each other, a width of the mating portion 232 is greater than the sum W1 of the widths of the two contact portions 2334, and a width W3 of each contact portion 2334 in the left-right direction is less than a width W4 of the second arm portion 2332, such that the impedance of the location of the conductive terminal 23 in contact with the metal pad 31 is reduced, which is conducive to the overall impedance matching of the conductive terminal 23.

Referring to FIG. 2 to FIG. 5, in the present embodiment, the base 231 is in a flat plate shape, and the two tearing surfaces 2335 are located at a front side and a rear side of the base 231 along the front-rear direction. The two clastic arms 2330 of the same conductive terminal 23 are symmetrical by 180° rotating in FIG. 3, and are mirror symmetrical relative to a central axial line L of the base 231 in FIG. 4. Thus, referring to FIG. 3 and FIG. 4, in the same conductive terminal 23, lengths, corresponding widths and shapes of the two elastic arms 2330 are substantially identical, the lengths and widths of the two first arm portions 2331 are substantially identical, the lengths, widths and bending radii of the two bending portions 2333 are substantially identical, the lengths and widths of the two second arm portions 2332 are substantially identical, and a farthest distance between each of the two bending portions 2333 and the base 231 of the same conductive terminal 23 in the front-rear direction is substantially equal. Thus, the two elastic arms 2330 of the same conductive terminal 23 have identical electrical characteristics, which helps reducing the signal loss when the conductive terminal 23 transmits high frequency signals. In addition, when the two conductive terminals 23 are provided in the shielding sleeve 21, the two conductive portions 233 are correspondingly exposed from the bottom portion (not shown) of the insulating block 22, in each conductive terminal 23, an interval between one elastic arm 2330 and the shielding sleeve 21 in the front-rear direction and an interval between the other elastic arm 2330 and the shielding sleeve 21 in the front-rear direction are substantially equal (not shown), and portions of the two first arm portions of the conductive terminal 23 substantially extend horizontally along the front-rear direction. Thus, the distance between each of the two first arm portions 2331 and the insulating block 22 in the up-down direction is correspondingly equal and maintains substantially unchanged. Accordingly, the medium around each elastic arm 2330 is distributed uniformly, such that the signals in the two transmission paths established by the two elastic arms 2330 of each conductive terminal 23 are subjected to identical impedances. In addition, the two conductive portions 233 of the two conductive terminals 23 forming the differential terminal group are symmetrical by rotating, a front-rear interval and a left-right interval between one conductive portion 233 and the shielding sleeve 21 and a front-rear interval and a left-right interval between the other conductive portion 233 and the shielding sleeve 21 are substantially equal (not shown). Thus, the magnetic field around the two conductive portions 233 are distributed uniformly, preventing the two conductive terminals 23 transmitting the differential signals from timing skew, and ensuring the signal completeness. Regarding the terms “substantially identical” and “substantially equal” in the descriptions, tolerances exist in the manufacturing technology, and the tolerance range of ±0.2 mm is allowed, meaning that any measurement within this tolerance range may be considered substantially identical or substantially equal. In the present embodiment, the first arm portion 2331 is directly connected to the base 231. In other embodiments, other structures, such as an additional third arm portion and a connecting portion connecting the third arm portion to the first arm portion 2331, may be additionally provided between the first arm portion 2331 and the base 231.

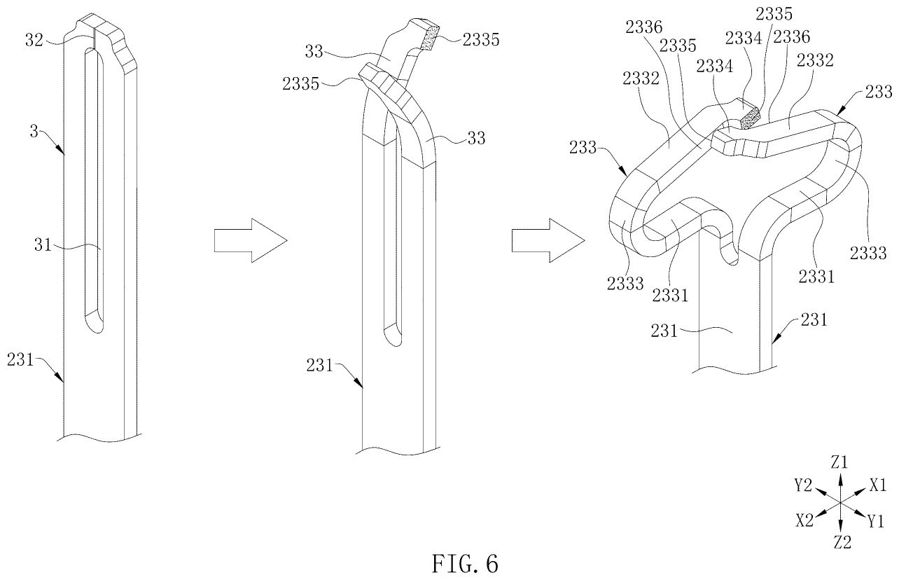

The forming method of the conductive portion 233 is described with reference to FIG. 6. Firstly, a metal substrate is provided, and the base 231 and a ring portion 3 are formed on the metal substrate by punching and blanking technology. The ring portion 3 is connected to the base 231 and has a through hole 31 at a center thereof. A tail end of the ring portion 3 has a pre-breaking slot 32 connected to the through hole 31. The term “blanking” refers to punching the mold and cutting the redundant portion on the metal substrate which is not used for subsequent machining. An outer boundary of the ring portion 3 and a boundary of the through hole 31 form a blanking surface 2336 generated by the blanking technology. Then, the tail end of the ring portion 3 is broken by punching and tearing technology, and the ring portion 3 is broken along the pre-breaking slot 32 to form two extending portions 33 splitting in the front-rear direction. A tail end of each extending portion 33 has a tearing surface 2335 formed by breaking with the pre-breaking slot 32. The term “tearing” refers to punching the mold such that the two portions originally belonging to the same metal plate move toward opposite directions, thus tearing the portion originally connecting the two portions, and the tearing technology does not apparently reduce the material. The tearing surface 2335 is a breaking surface generated at the location of the pre-breaking slot 32 by moving the two extending portions 33 along opposite directions. Finally, the two extending portions 33 bend respectively by a bending jig to form the two elastic arms 2330. The tail end of each extending portion 33 functions as the contact portion 2334, and the blanking surface 2336 of the through hole 31 forms the blanking surface 2336 of the clastic arm 2330 located between the contact portion 2334 and the base 231. The two tearing surfaces 2335 of the two clastic arms 2330 are respectively located at a side of the two contact portions 2334 of the two elastic arms 2330 adjacent to each other, the two contact portions 2334 of the two elastic arms 2330 are provided to be staggered along the front-rear direction, and the two tearing surfaces 2335 are provided to be separated along the front-rear direction.

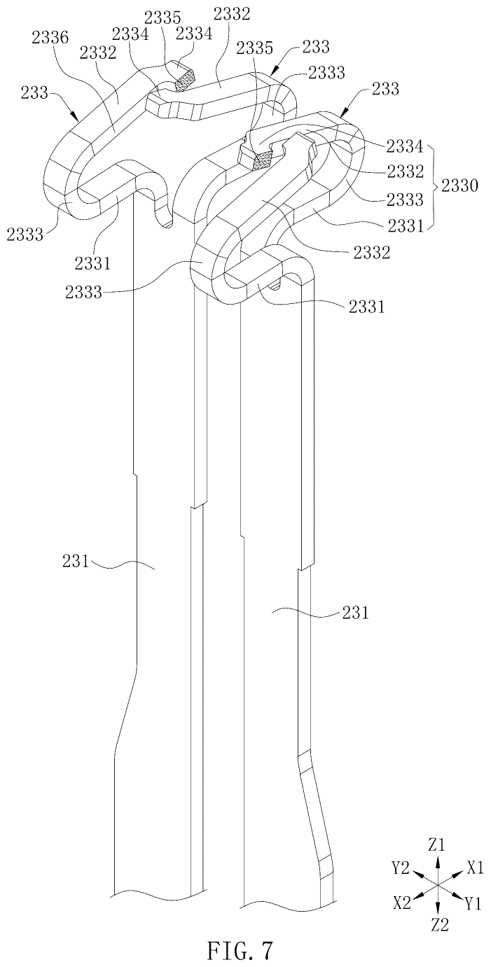

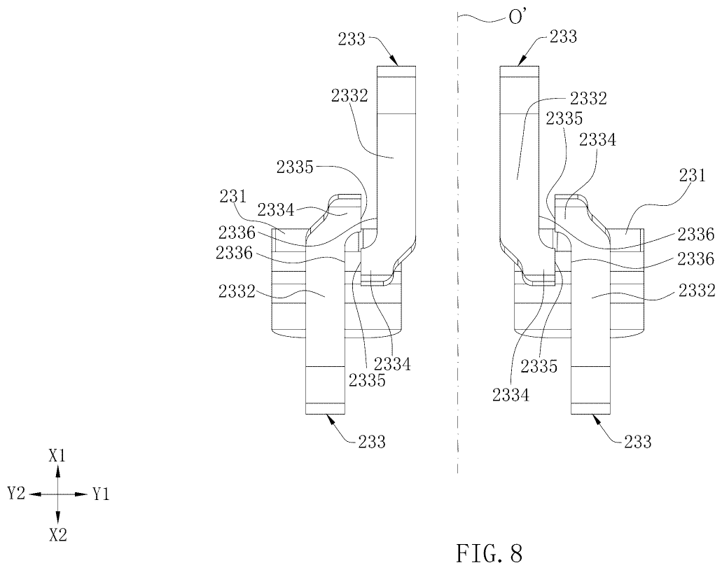

FIG. 7 to FIG. 8 are schematic views of the differential terminal group according to a second embodiment. Referring to FIG. 8, in the present embodiment, the two conductive portions 233 of the same differential terminal group are side-by-side along the left-right direction and are mirror symmetrical relative to a central line O′ of an interval therebetween. That is, the perpendicular projections of the two conductive portions 233 of the same differential terminal group on the circuit board 4 are mirror symmetrical, and the symmetrical axis is the central line O′ of the interval therebetween. In the embodiment, the specific structures of the conductive portion 233 are identical to the specific structures of the conductive portion 233 in the first embodiment.

The conductive terminal and the electrical connector according to certain embodiments of the present invention have the following beneficial effects:
(1) The contact portion 2334 is located at the tail end of the elastic arm 2330 and does not form an open stub when it elastically contacts with the metal pad 41, thus preventing from generating the high frequency resonance and corresponding electromagnetic interferences. The two tearing surfaces 2335 allows the distance between the two contact portions 2334 in the left-right direction to be minimized, and on the premise of not reducing the original width of the contact portion 2334, the dimension of the metal pad 41 of the circuit board 4 simultaneously in contact with the two contact portions 2334 in the left-right direction may be correspondingly reduced, thus preventing the metal pad 41 from having an excessively low impedance, and effectively enhancing the lowest impedance value of the entire system in transmitting signals at the rate of 224 Gb/s, which helps the entire electrical connecting system to facilitate better characteristic impedance matching, and reduces the signal attenuation at the rate of 224 Gb/s. In addition, the two second arm portions 2332 extend to be close toward each other in the front-rear direction, which, compared to the case where each elastic arm is only provided with the first arm portion, the contact portion is provided at a tail end of the first arm portion, and the contact portions of the two first arm portions of the same conductive terminal are away from each other in the related art, the elastic arm stop at the first arm and the contact portion is provided at the tail end of the first arm, the two second arm portions 2332 extend to be close toward each other in the front-rear direction may allow the two contact portions 2334 respectively located at the tail ends of the two second arm portions 2332 to be close to each other in the front-rear direction, and correspondingly reduce the dimension of the metal pad 41 in the front-rear direction, thus preventing the metal pad 41 from having an excessively low impedance, and effectively enhancing the lowest impedance value of the entire system in transmitting signals at the rate of 224 Gb/s, which helps the entire electrical connecting system to facilitate better characteristic impedance matching, and reduces the signal attenuation at the rate of 224 Gb/s. In addition, the two contact portions 2334 of the two elastic arms 2330 are provided to be staggered along the front-rear direction, and the two tearing surfaces 2335 are provided to be separated along the front-rear direction. The two tearing surfaces 2335, after elastically abutting against the metal pad 41, move away from each other along the respective extending directions of the two second arm portions 2332, thus preventing the two tearing surfaces 2335 closest to each other on the two elastic arms 2330 from scratching and colliding with each other in the elastic compression process of the elastic arms 2330, thereby preventing the two contact portions 2334 from failing to align to and abut against the same metal pad 41 due to colliding with each other.
(2) The lengths, corresponding widths and shapes of the two elastic arms 2330 are substantially identical, such that the lengths of the conductive paths of the two elastic arms 2330 are equal, and the same signal may simultaneously reach the metal pad 41 after passing through the two elastic arms 2330, thus preventing from the periodic resonance caused by asynchronous signal transmission due to unequal conductive paths.
(3) The tearing surface 2335 of each of the two elastic arms 2330 and the blanking surface 2336 of the other of the elastic arms 2330 are opposite to each other in the left-right direction, and each contact portion 2334 extends toward the second arm portion 2332 of the other elastic arm 2330 in the left-right direction. The sum W1 of widths of the two contact portions 2334 in the left-right direction is less than the sum W2 of the widths of the two second arm portions 2332 and the interval between the two blanking surfaces 2336. That is, a sum W1 of widths of the two contact portions 2334 in the left-right direction is less than a distance W2 between two edges of the two second arm portions 2332 of the two elastic arms 2330 away from each other, thus further reducing the areas of the two contact portions 2334, and further reducing the area of the metal pad 41 correspondingly.
(4) In certain cases, the two tearing surfaces 2335 are provided, and the two contact portions 2334 of the same conductive portion 233 are separated by tearing, such that the gap between the two contact portions 2334 in the left-right direction is as small as possible, and the contact areas between the two contact portions 2334 and the metal pad 41 are increased without expanding the area of the metal pad 41, which is conducive to allowing the contact portions 2334 to be fully in contact with the metal pad 41, and increasing the reliability of the contact between the contact portions 2334 and the metal pad 41.
(5) The two elastic arms 2330 integrally extend from the same base 231 simultaneously, which increases the signal transmission paths without the need of separately forming the two elastic arms independent from each other and then soldering and fixing the two elastic arms to the base 231, thus avoiding the need to provide an additional new mold due to the additional independent elastic arm, and reducing the cost of manufacturing the mold for the conductive terminal 23.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A conductive terminal, comprising:
a base, extending along an up-down direction; and
a conductive portion, connected to the base and configured to elastically abut against a circuit board;
wherein the conductive portion comprises two elastic arms, each of the elastic arms comprises a first arm portion and a second arm portion separated along the up-down direction, a bending portion connecting the first arm portion and the second arm portion, and a contact portion located at a tail end of the second arm portion, the two first arm portions of the two elastic arms extend to be away from each other in a front-rear direction, the two second arm portions of the two elastic arms extend to be close to each other in the front-rear direction, the contact portion of each of the two elastic arms has a tearing surface facing toward the second arm portion of the other of the two elastic arms, a distance between the two tearing surfaces of the two elastic arms in a left-right direction is a shortest distance between the two elastic arms in the left-right direction, the two contact portions of the two elastic arms are provided to be staggered along the front-rear direction, and the two tearing surfaces are provided to be separated along the front-rear direction.

2. The conductive terminal according to claim 1, wherein the first arm portion is directly connected to the base, one of the two tearing surfaces of the two elastic arms passes beyond a front side of the base, and the other of the two tearing surfaces passes beyond a rear side of the base.

3. The conductive terminal according to claim 1, wherein lengths, corresponding widths and shapes of the two elastic arms are substantially identical.

4. The conductive terminal according to claim 1, wherein each of the elastic arms further has a blanking surface located between the contact portion and the base at a side adjacent to the other of the elastic arms, and the tearing surface of each of the two elastic arms and the blanking surface of the other of the elastic arms are opposite to each other in the left-right direction.

5. The conductive terminal according to claim 4, wherein the contact portion of each of the two elastic arms extends toward the second arm portion of the other of the two elastic arms in the left-right direction, and a sum of widths of the two contact portions of the two elastic arms in the left-right direction is less than a distance between two edges of the two second arm portions of the two elastic arms away from each other.

6. The conductive terminal according to claim 1, wherein the two tearing surfaces of the two elastic arms and a central axial line of the base extending along the up-down direction are located on a same vertical plane.

7. The conductive terminal according to claim 1, wherein a same side of the two contact portions of the two elastic arms along the up-down direction form two contact surfaces to collectively abut against a same metal pad of the circuit board.

8. The conductive terminal according to claim 1, wherein a width of the contact portion in the left-right direction is less than a width of the second arm portion, a mating portion extends from a side of the base away from the conductive portion along the up-down direction, and a width of the mating portion is greater than a sum of the widths of the two contact portions of the two elastic arms.

9. The conductive terminal according to claim 1, wherein a portion of each of the first arm portions of the elastic arms substantially extends horizontally along the front-rear direction.

10. An electrical connector, comprising:
an insulating body; and
a plurality of transmission modules fixed in the insulating body;
wherein each of the transmission modules comprises a shielding sleeve, an insulating block surrounded by the shielding sleeve and a differential terminal group fixed to the insulating block, the differential terminal group comprises two conductive terminals, each of the two conductive terminals comprises a base extending along an up-down direction, a mating portion connected to one side of the base and a conductive portion connected to the other side of the base, and the conductive portion is configured to be electrically connected to a circuit board;
wherein the conductive portion comprises two elastic arms, each of the elastic arms comprises a first arm portion and a second arm portion separated along the up-down direction, a bending portion connecting the first arm portion and the second arm portion, and a contact portion located at a tail end of the second arm portion, the two first arm portions of the two elastic arms extend to be away from each other in a front-rear direction, the two second arm portions of the two elastic arms extend to be close to each other in the front-rear direction, the contact portion of each of the two elastic arms has a tearing surface facing toward the second arm portion of the other of the two elastic arms in a left-right direction, each of the elastic arms further has a blanking surface located between the contact portion and the base at a side adjacent to the other of the elastic arms, a distance between the two tearing surfaces of the two elastic arms in the left-right direction is a shortest distance between the two blanking surfaces of the two elastic arms in the left-right direction, the two contact portions of the two elastic arms are provided to be staggered along the front-rear direction, and the two tearing surfaces are provided to be separated along the front-rear direction.

11. The electrical connector according to claim 10, wherein the two conductive portions of the same differential terminal group are side-by-side along the left-right direction and are symmetrical by 180° rotating around a central point of an interval therebetween.

12. The electrical connector according to claim 10, wherein the two conductive portions of the same differential terminal group are side-by-side along the left-right direction and are mirror symmetrical relative to a central line of an interval therebetween.

13. The electrical connector according to claim 10, wherein in a same one of the conductive terminals, one of the two tearing surfaces of the two elastic arms passes beyond a front side of the base, and the other of the two tearing surfaces passes beyond a rear side of the base.

14. The electrical connector according to claim 10, wherein in a same one of the conductive terminals, the tearing surface of each of the two elastic arms and the blanking surface of the other of the elastic arms are opposite to each other in the left-right direction.

15. The electrical connector according to claim 10, wherein a farthest distance between each of the two bending portions and the base of a same one of the conductive terminals in the front-rear direction is substantially equal.

16. The electrical connector according to claim 10, wherein in a same one of the conductive terminals, the contact portion of each of the two elastic arms extends toward the second arm portion of the other of the two elastic arms in the left-right direction, and a sum of widths of the two contact portions of the two elastic arms in the left-right direction is less than a distance between two edges of the two second arm portions of the two elastic arms away from each other.

17. The electrical connector according to claim 10, wherein a width of the contact portion in the left-right direction is less than a width of the second arm portion, and a width of the mating portion is greater than a sum of the widths of the two contact portions of the two elastic arms.

18. The electrical connector according to claim 10, wherein in a same one of the conductive terminals, the two contact portions of the two elastic arms collectively abut against a same metal pad of the circuit board.

19. The electrical connector according to claim 10, wherein in a same one of the conductive terminals, two projections of the two elastic arms along the up-down direction are symmetrical by 180° rotating.

20. A forming method of a conductive portion of a conductive terminal, comprising:
providing a metal substrate and forming a base and a ring portion of the conductive terminal on the metal substrate by punching and blanking technology, wherein the ring portion is connected to the base and has a through hole at a center thereof, and a tail end of the ring portion has a pre-breaking slot connected to the through hole;
breaking the tail end of the ring portion by punching and tearing technology, and breaking the ring portion along the pre-breaking slot to form two extending portions splitting in a front-rear direction, wherein a tail end of each of the extending portions has a tearing surface formed by breaking with the pre-breaking slot; and
bending the two extending portions respectively by a bending jig to form two elastic arms, wherein each of the elastic arms has a first arm portion connected to the base, a bending portion connected to the first arm portion, a second arm portion connected to the bending portion and a contact portion located at a tail end of the second arm portion, the two first arm portions of the two elastic arms extend from the base to be away from each other in a front-rear direction, the two second arm portions of the two elastic arms extend from the two bending portions of the two elastic arms to be close to each other in the front-rear direction, the two tearing surfaces of the two elastic arms are respectively located at a side of the two contact portions of the two elastic arms adjacent to each other, the two contact portions of the two elastic arms are provided to be staggered along the front-rear direction, and the two tearing surfaces are provided to be separated along the front-rear direction.
